(19) United States
(12) Patent Application Publication
(10) Pub. No.: US 2006/0109255 A1
(43) Pub. Date: May 25, 2006

(54) Notebook with touch pad module

(75) Inventor: Yu-Jen Chen, Kuei Shan Hsiang (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Quanta Computer Inc.

(21) Appl. No.: 11/107,604

(22) Filed: Apr. 15, 2005

(30) Foreign Application Priority Data
Nov. 24, 2004 (TW) 93218874

(51) Int. Cl. G09G 5/00

(52) U.S. Cl. 345/173

(57) ABSTRACT

A notebook and a touch pad module are disclosed. The notebook includes a main body and a touch pad module. The touch pad module is disposed on the main body, having a major surface with a first region and a minor surface with a second region. Area of the first region exceeds that of the second region.

### BACKGROUND

The invention relates to a notebook and particularly to a notebook with a touch pad module.

FIG. 1 shows a conventional notebook. A main body 11 of the notebook has a display 12. An input device of the notebook includes a keyboard module 13 to input such as characters, a touch pad module 14 which controls the cursor on the display 12 and two-button module 15 and 16 for executing respectively left and right key functions of a mouse.

However, the conventional notebook has a complicated structure, is difficult to assemble and is expensive. As an example, the two-button module requires several tests after assembly, costing time.

### SUMMARY

Accordingly, to solve the above-mentioned problems, the invention discloses a notebook comprising a main body and a touch pad module. The touch pad module is disposed on the main body, having a major surface with a first region and a minor surface with a second region. Area of the first region exceeds that of the second region.

The touch pad module is rectangular, first and second regions are rectangular, the main body comprises a flange surrounding the touch pad module. The main body comprises a protrusion disposed between the major and minor surfaces.

Alternatively, the second region of the minor surface may comprise a third region and a fourth region adjacent to the first region. Area of the first region exceeds that of the third region and the fourth region. The main body comprises a rib disposed between the third and fourth regions. The third region and the fourth region are rectangular.

As well, the second region of the minor surface may comprise a third region, a fourth region and a fifth region adjacent to the first region. Area of the first region exceeds that of the third region, the fourth region and the fourth region. The main body comprises two ribs respectively disposed between the third, the fourth and the fifth regions. The third, and the fourth and the fifth regions are rectangular.

Also disclosed is a touch pad module comprising a major surface having a first region and a minor surface adjacent to the major surface, having a second region. Area of the first region exceeds that of the second region.

The major and minor surfaces and first and second regions are rectangular.

The second region of the minor surface may comprise a third region and a fourth region adjacent to the first region. Area of the first region exceeds that of the third region and the fourth region. The third region and the fourth region are rectangular.

The second region of the minor surface may comprise a fifth region adjacent to the first, the third and the fourth regions. Area of the first, the third and the fourth region exceeds that of the fourth region. The fourth region is rectangular.

A detailed description is given in the following embodiments with reference to the accompanying drawings.

### DESCRIPTION OF THE DRAWINGS

The invention can be more fully understood by reading the subsequent detailed description in conjunction with the examples and references made to the accompanying drawings, wherein:

FIG. 1 is a schematic view of a conventional notebook;

FIG. 2A is a schematic view of a notebook of the invention;

FIG. 2B is a schematic view of a touch pad module of an embodiment of the invention;

FIG. 2C is a schematic view of a touch pad module of another embodiment of the invention;

FIG. 2D is a schematic view of a touch pad module of another embodiment of the invention;

FIG. 3A is a schematic view of a touch pad module of another embodiment of the invention;

FIG. 3B is a schematic view of a touch pad module of another embodiment of the invention; and

FIG. 4 is a schematic view of a touch pad module of another embodiment of the invention.

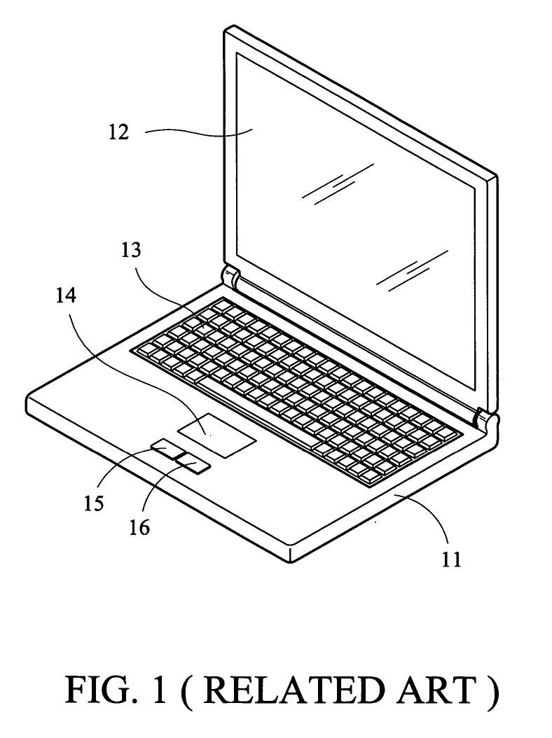

### DETAILED DESCRIPTION

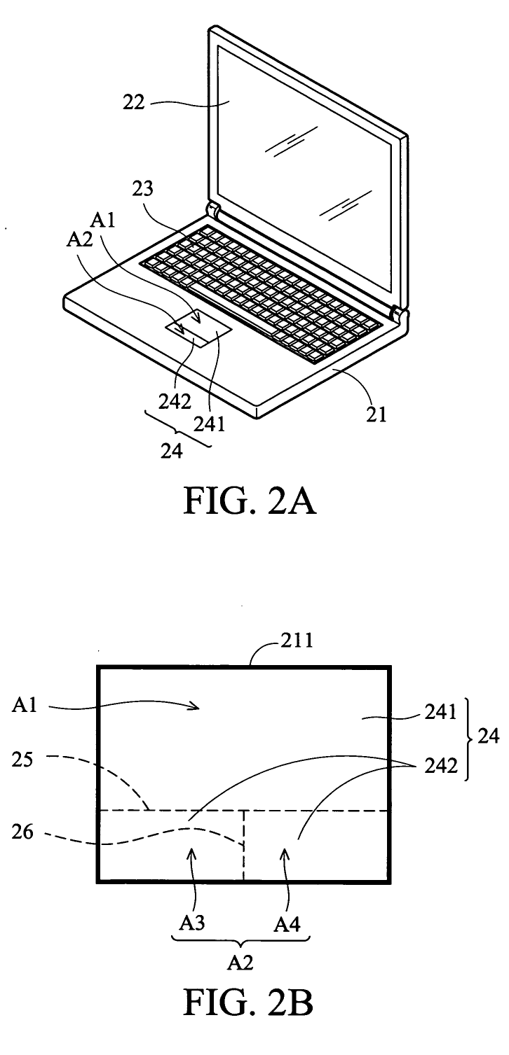

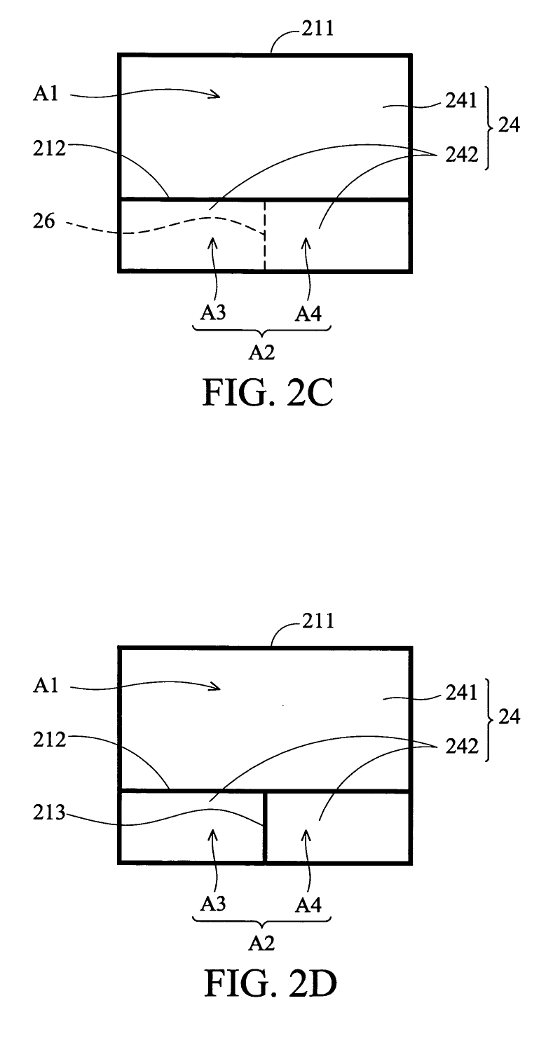

FIG. 2A depicts a notebook of the invention comprising a main body 21, a display 22, a keyboard module 23 and a touch pad module 24. The display 22, keyboard module 23 and touch pad module 24 are disposed on the main body 21.

The touch pad module 24 is substantially rectangular, having a major surface 241 and a minor surface 242. The major surface 241 has a first region A1 and the minor surface 242 has a second region A2. The area of the second region A2 is less than that of the first region A1. Description of the structure and function of the touch pad module 24 are follows.

Referring to FIG. 2B, a flange 211 of the main body 21 surrounds the touch pad module 24. A line 25 separates the major surface 241 and the minor surface 242. On minor surface 242, another line 26 separates the second region A2 into a third region A3 and a fourth region A4. The first region A1, the second region A2, the third region A3 and the fourth region A4 are substantially rectangular. The third region A3 and the fourth region A4 are adjacent to the first region A1. The area of the second region A2, including the third region A3 and the fourth region A4, is less than that of the first region A1. Additional, the line 25 and the line 26 may be any pattern and directly formed on the touch pad module 24.

Upon user contact with the first region A1 of the major surface 241, the cursor on the display 22 responds. Contact or “clicking” the third region A3 of the minor surface 242 generates left mouse key function (such as select). Contact or “clicking” the fourth region A4 of the minor surface 242 generates right mouse key function (such as context menu).

FIG. 2C shows an embodiment in which the major surface 241 and the minor surface 242 of the touch pad module 24 are separated by a protrusion 212 of the main body 21. The function of the major surface 241 and the minor surface 242 are as described previously.

FIG. 2D shows an embodiment in which the third region A3 and the fourth region A4 of the minor surface 242 are separated by a rib 213 of the main body 21. The function of the major surface 241 and the minor surface 242 are as described previously.

The described line, protrusion and rib may vary with demand, are alternatively applied, and are not limited to the description.

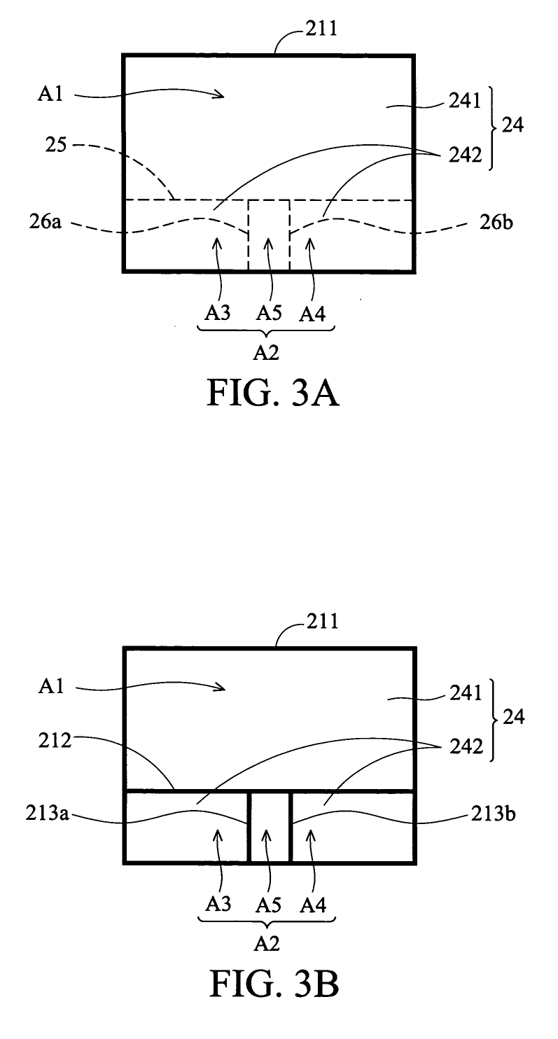

FIG. 3A shows an embodiment in which the touch pad module 24 is separated into the major surface 241 and the minor surface 242 by the line 25. The major surface 241 has a first region A1 and minor surface 242 has a second region A2. The second region A2 of the minor surface 242 is separated into a third region A3, a fourth region A4 and a fifth region A5 by two lines 26a and 26b. The first region A1, the second region A2, the third region A3, the fourth region A4 and the fifth region A5 are substantially rectangular. The third region A3, the fourth region A4 and the fifth region A5 are adjacent to the first region A1. The area of the second region A2, including the third region A3, the fourth region A4 and the fifth region A5, is less than that of the first region A1. Additionally, the line 25, 26a and 26b may be any pattern and directly formed on the touch pad module 24.

Upon user contact with the first region A1 of the major surface 241, the cursor on the display 22 responds. Contact or “clicking” the third region A3 of the minor surface 242 generates left mouse key function (such as select). Contact or “clicking” the fourth region A4 of the minor surface 242 generates right mouse key function (such as context menu). Contact or “clicking” the fifth region A5 of the minor surface 242 generates the middle mouse key function (such as double click).

FIG. 3B shows an embodiment in which the major surface 241 and the minor surface 242 of the touch pad module 24 are separated by a protrusion 212 of the main body 21. The third region A3, the fourth region A4 and the fifth region A5 are separated by two ribs 213a and 213b of the main body 21. The function of the major surface 241 and the minor surface 242 are as described previously.

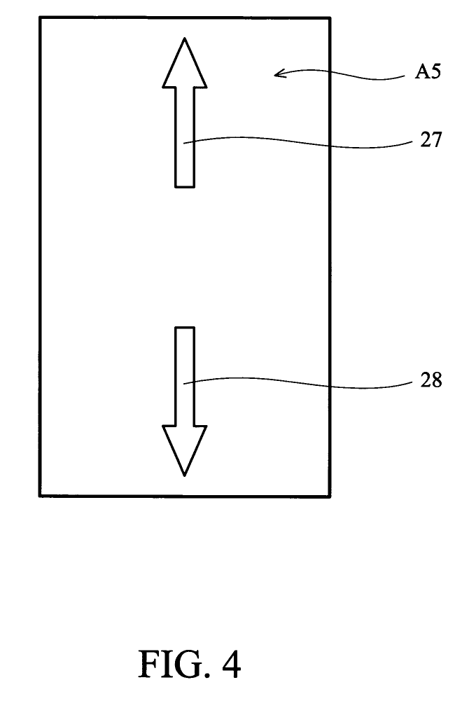

FIG. 4 only depicts the fifth region A5 of the minor surface 242 in an embodiment in which a first mark 27 (such as an arrow) and a second mark 28 (such as an arrow with opposite direction) are formed on the fourth region A4 such that user contact with the fourth region A4 generates mouse wheel function. For example, upon user contact near the first mark 27 and moving toward the tip of the arrow generates mouse wheel function, rolling up the window on the display 22. Contact near the second mark 28 and moving toward the tip of the arrow generates mouse wheel function, rolling down the window on the display 22.

The described line, protrusion and rib may vary with demand, are alternatively applied, and are not limited to the description.

Furthermore, the function of the major surface and the minor surface may also vary with demand, and are not limited to the described.

While the invention has been described by way of example and in terms of preferred embodiment, it is to be understood that the invention is not limited thereto. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A notebook, comprising:
a main body; and
a touch pad module disposed on the main body, comprising a major surface with a first region and a minor surface with a second region, wherein an area of the first region exceeds an area of the second region.

2. The notebook as claimed in claim 1, wherein the touch pad module is rectangular.

3. The notebook as claimed in claim 1, wherein the first and second regions are rectangular.

4. The notebook as claimed in claim 1, wherein the main body comprises a flange surrounding the touch pad module.

5. The notebook as claimed in claim 1, wherein the main body comprises a protrusion disposed between the major and minor surfaces.

6. The notebook as claimed in claim 1, wherein the second region of the minor surface comprises a third region and a fourth region adjacent to the first region, and an area of the first region exceeds an area of the third region.

7. The notebook as claimed in claim 6, wherein the main body comprises a rib disposed between the third and the fourth regions.

8. The notebook as claimed in claim 6, wherein the third region and the fourth region are rectangular.

9. The notebook as claimed in claim 1, wherein the second region of the minor surface comprises a third region, a fourth region and a fifth region adjacent to the first region, and an area of the first region exceeds an area of the third region, the fourth region and the fifth region.

10. The notebook as claimed in claim 9, wherein the main body comprises two ribs respectively disposed between the third, the fourth and the fifth regions.

11. The notebook as claimed in claim 9, wherein the third, the fourth and the fifth regions are rectangular.

12. A touch pad module, comprising:
a major surface comprising a first region; and
a minor surface adjacent to the major surface, comprising a second region, wherein an area of the first region exceeds an area of the second region.

13. The touch pad module as claimed in claim 12, wherein the major and minor surfaces are rectangular.

14. The touch pad module as claimed in claim 12, wherein the first and second regions are rectangular.

15. The touch pad module as claimed in claim 12, wherein the second region of the minor surface comprises a third region and a fourth region adjacent to the first region, and an area of the first region exceeds an area of the third region and the fourth region.

16. The touch pad module as claimed in claim 15, wherein the third region and the fourth region are rectangular.

17. The touch pad module as claimed in claim 15, wherein the second region of the minor surface further comprises a fifth region adjacent to the first, the third and the fourth regions, and an area of the first, the second, the third and the fourth region exceeds an area of the fifth region.

18. The touch pad module as claimed in claim 17, wherein the fifth region is rectangular.
